(19) United States
(12) Patent Application Publication
(10) Pub. No.: US 2011/0149827 A1
(43) Pub. Date: Jun. 23, 2011

(54) BASE STATION, MOBILE STATION, AND METHOD FOR PROVIDING SERVICE CONTINUITY BETWEEN MBMS AREAS IN MOBILE TELECOMMUNICATION SYSTEM

(75) Inventors: JeeHyeon NA, Daejeon (KR); Dae Ik KIM, Daejeon (KR); Sang Ho LEE, Daejeon (KR)

(73) Assignee: ELECTRONICS AND TELECOMMUNICATIONS RESEARCH INSTITUTE, DAEJEON (KR)

(21) Appl. No.: 12/973,379

(22) Filed: Dec. 20, 2010

(30) Foreign Application Priority Data
Dec. 21, 2009 (KR) 10-2009-0128474

(51) Int. Cl. H04W 4/06

(52) U.S. Cl. 370/312

(57) ABSTRACT

Provided are a base station, a mobile station, and a method for providing service continuity between Multimedia Broadcast and Multicast Service (MBMS) areas. A system information generation unit of the base station may generate a System Information Block (SIB) including broadcasting area information providing a broadcasting service to a neighboring cell of a serving cell where the mobile station is located. A communication unit may transmit the generated SIB to the mobile station.

### CROSS-REFERENCE TO RELATED APPLICATION

This application claims the benefit of Korean Patent Application No. 10-2009-0128474, filed on Dec. 21, 2009, in the Korean Intellectual Property Office, the disclosure of which is incorporated herein by reference.

### BACKGROUND

1. Field of the Invention

Embodiments of the present invention relate to a base station, a mobile station, and a method for providing service continuity between Multimedia Broadcast and Multicast Service (MBMS) areas, which may provide the service continuity when a mobile station is moved between broadcasting areas while receiving a broadcasting service in a mobile telecommunication system.

2. Description of the Related Art

As for mobile broadcasting services, when an area providing the mobile broadcasting services is changed by a movement of a mobile station where a mobile broadcasting service function is loaded, a disruption phenomenon of the service may occur. To overcome the disruption phenomenon of the service, a technology using Global Positioning System (GPS) information has been introduced to provide service continuity. The GPS-related technology may ascertain area information where the mobile station is included, using the GPS information, and change a channel frequency based on the ascertained area information to continuously provide services.

However, in the GPS related technology, the area information of the mobile station and broadcasting information may need to be connected to each other every time a service area is changed, and need to use a GPS device, which results in causing inconvenience.

In addition, a mobile communication system may use a Multimedia Broadcast and Multicast Service (MBMS) area ID for the purpose of classifying broadcasting service areas. The MBMS area ID may be used for scheduling a channel for each of the broadcasting service areas. However, since the information includes only the MBMS area ID for a current cell where the mobile station is currently located, a time period during which disruption of the service occurs when the mobile station is moved between the broadcasting service areas may be lengthened.

Accordingly, there is a desire for a base station, a mobile station, and a method for providing service continuity between the MBMS areas to minimize the disruption phenomenon of the service.

### SUMMARY

According to an aspect of the present invention, there is provided a base station for providing service continuity between Multimedia Broadcast and Multicast Service (MBMS) areas, the base station including: a system information generation unit to generate a system information block including information about a broadcasting area providing a broadcasting service to a neighboring cell of a serving cell where a mobile station is located; and a communication unit to transmit the generated system information block to the mobile station.

The information about the broadcasting area included in the system information block may include a service transmission scheme supported in a broadcasting area of the neighboring cell, identification information of the broadcasting area of the neighboring cell, and configuration information of a logical channel transmitting contents.

When the service transmission scheme is a single cell transmission scheme providing a service to only a single cell, the configuration information may include channel shape information about the single cell, and when the service transmission scheme is a multi-cell transmission scheme providing a service to a plurality of cells, the configuration information may include channel shape information about the transmission channel.

The system information block further include a flag indicating whether broadcasting areas providing the broadcasting service to the serving cell and the neighboring cell, respectively, are the same.

When the broadcasting area providing the broadcasting service to the neighboring cell and a broadcasting area providing the broadcasting service to the serving cell are different from each other, the system information generation unit may generate the system information block including information about the broadcasting area of the neighboring cell.

The broadcasting area may be one of a non-Multicast Broadcast Single Frequency Network (MBSFN) area and an MBSFN area.

According to another aspect of the present invention, there is provided a mobile station for providing service continuity between MBMS areas, while the mobile station receives a broadcasting service from a serving cell, the mobile station including: a communication unit to receive, from a base station, a system information block including information about a broadcasting area providing the broadcasting service to a neighboring cell of the serving cell; and a control unit to control the communication unit to receive, from the neighboring cell, the broadcasting service being received from the serving cell, using the information about the broadcasting area, when a broadcasting area of the neighboring cell obtained when the mobile station is moved and a broadcasting area of the serving cell are different from each other.

The information about the broadcasting area included in the received system information block may include a service transmission scheme supported in the broadcasting area of the neighboring cell, identification information of the broadcasting area of the neighboring cell, and configuration information of a logical channel transmitting contents.

When the service transmission scheme is a single cell transmission scheme providing a service to only a single cell, the configuration information may include logical channel shape information about the single cell, and when the service transmission scheme is a multi-cell transmission scheme providing a service to a plurality of cells, the configuration information comprises logical channel shape information about the transmission channel.

The control unit may verify whether the broadcasting area of the neighboring cell provides the broadcasting service being received from the serving cell, using the configuration information of the logical channel.

The system information block may further include a flag indicating whether the broadcasting area of the serving cell and the broadcasting area of the neighboring cell are the same, and the control unit may determine whether the neighboring cell is located in the broadcasting area different from the broadcasting area of the serving cell based on the flag.

Each of the broadcasting area of the serving cell and the broadcasting area of the neighboring cell may be one of a single cell transmission area providing a service to only a single cell, and a multi-cell transmission area providing a service to a plurality of cells.

Each of the broadcasting area of the serving cell and the broadcasting area of the neighboring cell may be a non-MBSFN area or an MBSFN area.

According to still another aspect of the present invention, there is provided a method of providing service continuity between MBMS areas with respect to a mobile station, while the mobile station receives a broadcasting service from a serving cell, the method including: receiving, from the serving cell, a system information block including information about a broadcasting area providing the broadcasting service to a neighboring cell of the serving cell; verifying whether a broadcasting area of the neighboring cell is different from a broadcasting area of the serving cell when the mobile station moves to the neighboring cell; and receiving, from the neighboring cell, the broadcasting service being received from the serving cell using the information about the broadcasting area, when the broadcasting area of the neighboring cell is different from the broadcasting area of the serving cell.

The information about the broadcasting area included in the received system information block may include a service transmission scheme supported in the broadcasting area of the neighboring cell, identification information of the broadcasting area of the neighboring cell, and configuration information of a logical channel transmitting contents.

When the service transmission scheme is a single cell transmission scheme providing a service to only a single cell, the configuration information may include logical channel shape information about the single cell, and when the service transmission scheme is a multi-cell transmission scheme providing a service to a plurality of cells, the configuration information may include logical channel shape information about the transmission channel.

After the verifying, the method may further include verifying whether the broadcasting area of the neighboring cell provides the broadcasting service being received from the serving cell, using the configuration information of the logical channel.

The system information block may further include a flag indicating whether the broadcasting area of the serving cell and the broadcasting area of the neighboring cell are the same, and the verifying may determine whether the neighboring cell is located in the broadcasting area different from the broadcasting area of the serving cell based on the flag.

Each of the broadcasting area of the serving cell and the broadcasting area of the neighboring cell may be one of a single cell transmission area providing a service to only a single cell, and a multi-cell transmission area providing a service to a plurality of cells.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a case where a mobile station is moved between Multimedia Broadcast and Multicast Service (MBMS) areas, while receiving a broadcasting service in a mobile communication network;

FIG. 2 is a diagram illustrating a system of a mobile communication network for providing a broadcasting service according to an embodiment of the present invention;

FIG. 3 is a flowchart illustrating a process where two broadcasting areas mapped in the same broadcasting service identifier (ID) provide broadcasting services according to an embodiment of the present invention;

FIG. 4 is a block diagram illustrating a base station and a mobile station for service continuity between MBMS areas.

FIG. 5 is a diagram illustrating a neighboring cell information area among system information blocks according to an embodiment of the present invention;

FIG. 6 is a diagram illustrating information included in a neighboring cell information area of a System Information Block (SIB) when an MBMS type is a multi-cell transmission;

FIG. 7 is a diagram illustrating information included in a neighboring cell information area of an SIB when an MBMS type is a single cell transmission;

FIG. 8 is a flowchart illustrating a method of providing service continuity of a mobile station according to an embodiment of the present invention; and

FIG. 9 is a flowchart illustrating a method of providing service continuity of a mobile station according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

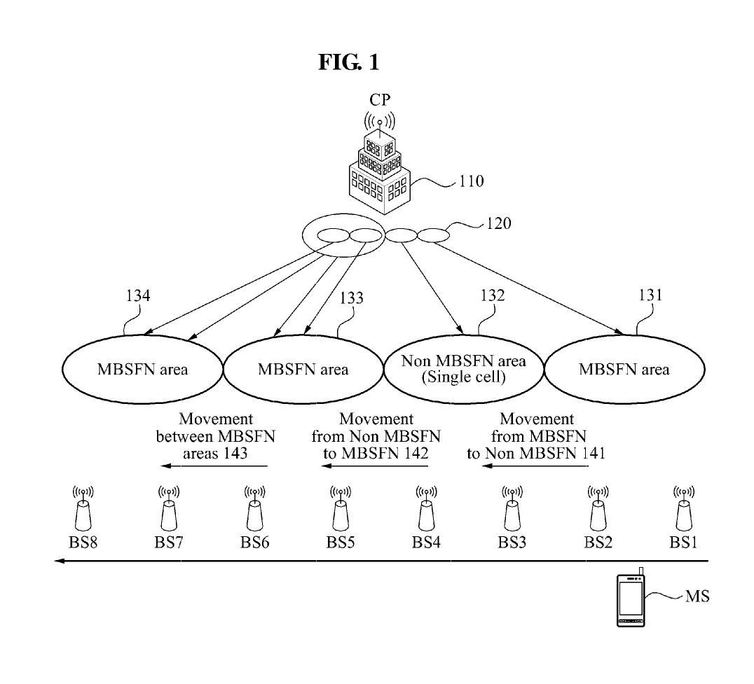

FIG. 1 is a diagram illustrating a case where a mobile station is moved between Multimedia Broadcast and Multicast Service (MBMS) areas, while receiving a broadcasting service in a mobile communication.

Referring to FIG. 1, the broadcasting service in the mobile communication network may be provided by a content provider (CP) 110. Some of the broadcasting services, that is, broadcasting channels may be provided, as the same contents, to a plurality of broadcasting areas, or provided as different contents depending on a local broadcasting CP 120. Specifically, the local broadcasting CP 120 may be a CP providing contents to at least one broadcasting area, and the provided contents may be the same or different from each other.

In general, a radio mobile communication network may provide an MBMS in a single-cell transmission scheme or a multi-cell transmission scheme.

In a case of the single-cell transmission scheme, the MBMS may be provided in a single cell area, and a Multicast Traffic Channel (MTCH) or a Multicast Control Channel (MCCH) which is a logical channel may be mapped, for the purpose of Point-To-Multi-Point (PTMP) transmission, in a Downlink Shared Channel (DL-SCH), that is, a transmission channel.

In a case of the multi-cell transmission scheme, a synchronous transmission may be performed on the MBMS by base stations located in a plurality of cells within a unit area including the plurality of cells, that is, within an MBMS Single Frequency Network (MBSFN) area. The mobile station may receive and combine the MBMS data transmitted from the plurality of cells. In this case, the MTCH and the MCCH may be mapped in a Multicast Channel (MCH) for the purpose of the PTMP transmission.

A scheduling may be performed by base stations (eNB) in the single-cell transmission scheme, and a scheduling may be performed by a Multi-Cell/Multicast Coordination Entity (MCE), that is, an upper entity of a base station BS1 in the multi-cell transmission scheme. However, the performed scheduling may be merely an example, and the present invention is not limited thereto.

The MBMS area, that is, the broadcasting area, may be classified into a non-MBSFN area that may transmit contents to a single cell to broadcast only with respect to the single cell, and an MBSFN area that may transmit the same contents to a plurality of cells.

In a mobile station (MS) sequentially connected to base stations BS1 to BS8 by a movement of the MS, a movement 141 from an MBSFN area 131 to a non-MBSFN area 132, a movement 142 from the non-MBSFN area 132 to an MBSFN area 133, and a movement 143 between the MBSFN areas 133 and 134 may be possible. The base stations BS1 to BS8 may be denoted by ‘eNB’.

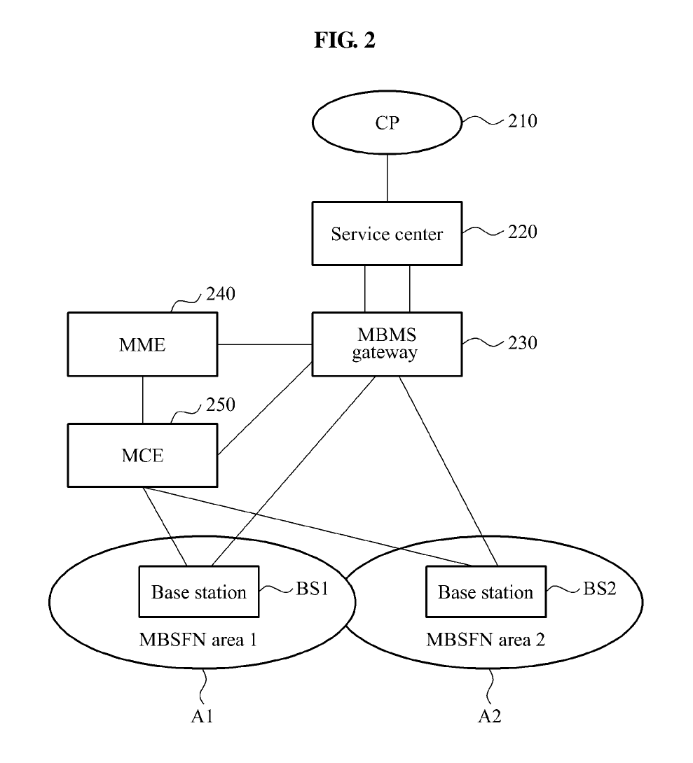

FIG. 2 is a diagram illustrating a system of a mobile communication network for providing a broadcasting service according to an embodiment of the present invention.

Referring to FIG. 2, the system of the mobile communication network includes a content provider (CP) 210, a service center 220, an MBMS gateway 230, a Mobility Management Entity (MME) 240, an MCE 250, and base stations BS1 and BS2.

The CP 210 may provide contents of a corresponding channel or a corresponding program, and may be classified into a primary CP and a local CP. Accordingly, the CP 210 may be the CP 110 or the local broadcasting CP 120 of FIG. 1.

The service center 220 may perform a mapping between the local broadcasting CP 210 and a broadcasting area, and an Evolved Broadcast/Multicast Service Center (eBM-SC) may be given as an example of the service center 220.

The service center 220 may manage such that the same broadcasting service identifier (ID) is allocated to the same broadcasting service or the same broadcasting channel. Also, the service center 220 may manage mapping information represented as the following Table 1, such that a corresponding content is transmitted to the same broadcasting service ID in accordance with areas.

TABLE 1

| MBSFN area ID | Contents |
|---|---|
| 1 | Program 1 |
| 2 | Program 2 |
| 3 | Program 2 |
| . . . | . . . |

As shown in Table 1, even with respect to the same broadcasting service ID, identical or different contents, that is, identical or different programs may be provided to each of the MBSFN areas.

Also, the service center 220 may generate a message informing about a start of the broadcasting service performed by the local CP 210. Specifically, the service center 220 may generate a session start request message including a broadcasting area ID and a broadcasting service ID which are mapped with the local CP 210, and transmit the generated session start request message to the MBMS gateway 230 of the related broadcasting area. The related broadcasting area may be an area mapped with the local CP 210. A plurality of local CPs may be mapped in a single broadcasting area ID, and a single local CP 210 may provide at least one broadcasting service.

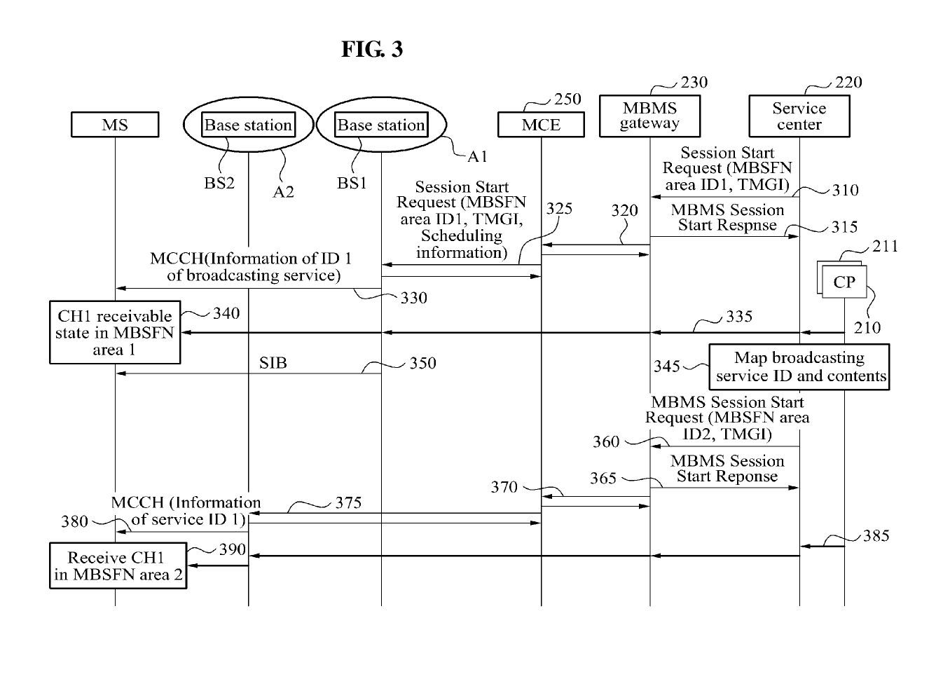

The broadcasting area may include an MBSFN area and a non-MBSFN area as described above, and the MBSFN area is described in FIGS. 2 and 3.

The MBMS gateway 230 may transmit the session start request message to the MCE 250 of the MBSFN area, and transmit a broadcasting-related signal and information related to traffic. The single MBMS gateway 230 may cover a plurality of MBSFN areas.

In general, the MME 240 may disperse a paging message to the base station BS1, and perform various functions such as security control, mobility control, and the like. Also, the MME 240 may transmit, to the base station BS1, signal information about the broadcasting service. The transmitted signal information may be information relating to the session start request message, and include an MBMS service ID, Quality of Service (QoS) information, a service start time, and the like.

The MCE 250 may allocate, to each of the MBSFN areas, the resource as a radio sub frame, and manage the allocated resource. Also, the MCE 250 may provide, to the base station BS1, radio scheduling signal information including information about the allocated resource. In general, a single MBSFN area may include a plurality of base stations.

The base station BS1 may receive, from the MCE 250, the radio scheduling signal information, and schedule traffic received from the MBMS gateway, based on the received radio scheduling signal information. The radio scheduling signal information may be information about a priority where a corresponding broadcasting service is scheduled.

Also, the base station BS1 may provide a broadcasting service using a result of the scheduling and a radio channel. A single MBSFN area A1 or A2 may include at least one cell, that is, at least one base station. In FIGS. 2 and 3, for convenience of description, a single base station is illustrated in a single MBSFN area.

FIG. 3 is a flowchart illustrating a process where two broadcasting areas mapped in the same broadcasting service identifier (ID) provide broadcasting services according to an embodiment of the present invention.

Referring to FIG. 3, providing of broadcasting services by two different local broadcasting stations may denote providing of a broadcasting service having the same ID by two MBSFN areas A1 and A2. Accordingly, contents of the broadcasting service provided from the two MBSFN areas A1 and A2 may be the same or different from each other.

In operation 310, the service center 220 may generate an MBMS session start request message when a broadcasting service of a corresponding local broadcasting station starts to be provided, and transmit the generated message to the MBMS gateway 230 located in each of the MBSFN areas. According to an embodiment, the MBMS session start request message may include a broadcasting service ID (TMGI=SERVICE ID1) and an MBSFN area ID 1. The broadcasting service ID may be added in a parameter of the message in a type of a Temporal MBMS Group Identifier (TMGI). The broadcasting service ID may be a broadcasting channel ID.

In operation 315, the MGMS gateway 230 may transmit an MBMS session start response message to the service center 220 in response to the MBMS session start request message.

In operation 320, the MBMS gateway 230 may transmit the session start request message to the MCE 250 of the MBSFN area A1.

In operation 325, the MCE 250 may transmit the session start request message to the base station BS1 of the MBSFN area A1. In this instance, the MCE 250 may reserve a radio resource for a broadcasting service of the corresponding MBSFN area A1, and transmit, to the base station BS1, radio scheduling signal information, that is, information relating to the reserved radio resource together with the session start request message.

In operation 330, the base station BS1 may verify the broadcasting service ID from the received message, and may inform a mobile station (MS) located within a corresponding cell about MBMS Traffic Channel (MTCH) information regarding a starting broadcasting service and the broadcasting service ID, using an MBMS Control Channel (MCCH).

In operation 335, when the session start request message is transmitted and a local broadcasting service starts to be provided, the CP 210 or the service center 220 may broadcast an information related to traffic to the MBSFN area A1. Here, the information related to traffic may be transmitted to the MS.

In operation 340, the MS may receive a broadcasting service of a corresponding area.

In operation 345, the service center 220 may map information about a CP 210, that is, a local broadcasting service provider providing a broadcasting service, that is, a broadcasting channel with the MBSFN area information, and store the mapped information. Alternatively, in operation 345, the service center may map the broadcasting service ID with information about currently provided contents, and store the mapped information.

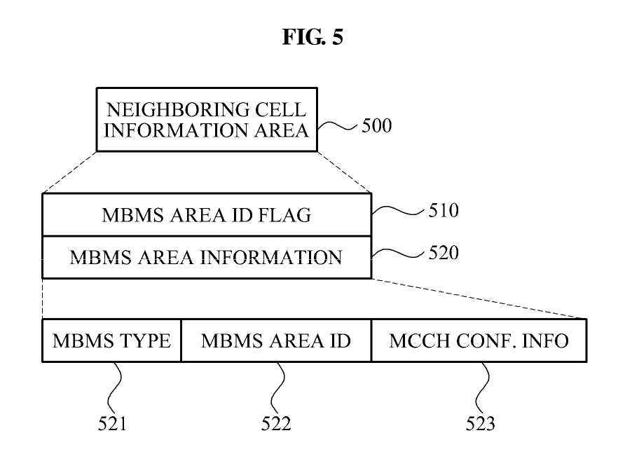

In operation 350, the base station BS1 may periodically broadcast, to the MS, a system information block, which will be described with reference to FIG. 5.

In operations 360 to 380, a process where broadcasting services having the same ID start to be provided in another MBSFN area A2 is described, and further descriptions thereof will be herein omitted since operations 360 to 380 are identical to operations 310 to 345. However, an MBSFN area ID 2 included in a message transmitted in operation 360 and the MBSFN area ID 1 included in the message transmitted in operation 310 may be different from each other, and have the same broadcasting service ID (TMGI=SERVICE ID1).

In operation 385, the CP 210 or the service center 220 may broadcast information related to traffic to the MBSFN area A2, and the information related to traffic may be transmitted to the MS.

According to an embodiment, through the process described in FIG. 3, the MS may receive the same or different contents for each of the broadcasting areas, with respect to the same broadcasting service (for example, the same channel).

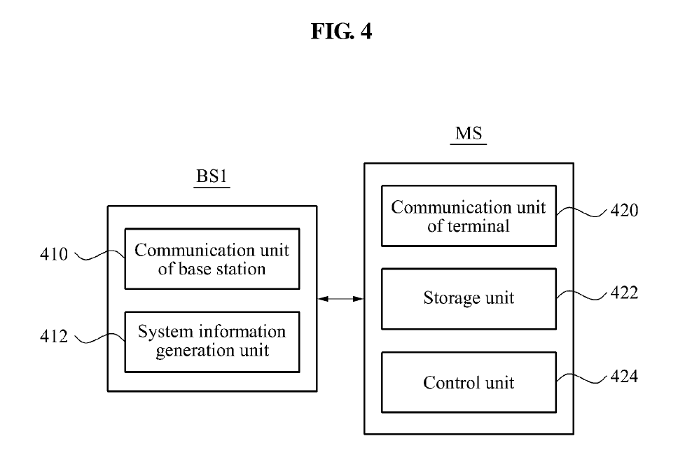

FIG. 4 is a block diagram illustrating a base station BS1 and a mobile station (MS) for service continuity between MBMS areas.

Referring to FIG. 4, the base station BS1 includes a base station communication unit 410 and a system information generation unit 412.

The base station communication unit 410 may periodically transmit, to the mobile station (MS) located in a serving cell, a System Information Block (SIB) generated in the system information generation unit 412, or transmit, to the mobile station (MS), the SIB when the SIB is changed.

The base station BS1 may inform the mobile station (MS) about basic information used for being connected to a network, using the SIB. The system information may include information required for performing a communication between the mobile station (MS) and the base station.

The system information generation unit 412 may generate the SIB including broadcasting area information of a neighboring cell when the mobile station (MS) is located in a current serving cell. The system information generation unit 412 may add, to a neighboring cell information area 500 of the SIB, broadcasting area-related information (hereinafter, referred to as ‘broadcasting area information’). A broadcasting area of a neighboring cell may be an area providing broadcasting services to the neighboring cell. A method where the system information generation unit 412 generates the SIB is well-known in the related art, and thus further descriptions thereof will be herein omitted.

The serving cell, which will be further described, may be a cell where the mobile station (MS) is currently located, and the mobile station (MS) may receive broadcasting services from a base station of the serving cell. Also, the neighboring cell may be a cell located adjacent to the serving cell, and a plurality of neighboring cells may be provided. However, for convenience of description, a single neighboring cell may be provided. According to an embodiment, information about the neighboring cell may be included in the periodically generated SIB to be transmitted to the mobile station (MS), and may be used for providing mobility information between broadcasting areas as well as mobility information between cells.

The broadcasting area information added to the neighboring cell information area 500 may be information about a broadcasting area providing broadcasting services to the neighboring cell, and may be provided for service continuity between the same or different broadcasting areas. The broadcasting area may be the above described MBSFN area or non-MBSFN area.

FIG. 5 is a diagram illustrating a neighboring cell information area 500 among system information blocks according to an embodiment of the present invention.

Referring to FIG. 5, for providing continuity of broadcasting services, the neighboring cell information area 500 includes a first area 510 where an MBMS area ID flag is recorded and a second area 520 where an MBMS area information relating to a broadcasting area is recorded.

The system information generation unit 412 may indicate, using a flag set to ‘0’ or ‘1 whether a broadcasting area of a serving cell where a mobile station (MS) is currently located and a broadcasting area of a neighboring cell adjacent to the serving cell) are the same. For example, when the broadcasting areas of the serving cell and the neighboring cell are the same, the system information generation unit 412 may record ‘0’ in the first area 510, and when the broadcasting areas of the serving cell and the neighboring cell are different from each other, the system information generation unit 412 may record ‘1’ in the first area 510.

Also, when the broadcasting areas of the serving cell and the neighboring cell are different from each other, the system information generation unit 412 may generate an SIB including broadcasting area information of the neighboring cell. Specifically, when the broadcasting areas of the serving cell and the neighboring cell are different from each other, the system information generation unit 412 may record, in the second area 520, broadcasting area information of a specific neighboring cell. When a broadcasting area of a neighboring cell which the mobile station (MS) is moved to is the same as a broadcasting area of the serving cell, or when the neighboring cell does not support an MBMS, the system information generation unit 412 may process the second area 520 as ‘null’.

The broadcasting area information of the neighboring cell included in the SIB may include a service transmission scheme supported in the broadcasting area of the neighboring cell, identification information of the broadcasting area of the neighboring cell, and configuration information of a logical channel transmitting contents. Accordingly, the second area 520 where the broadcasting area information of the neighboring cell is recorded includes an MBMS type area 521, an MBMS area ID area 522, and a channel configuration information area 523.

The MBMS type area 521 may include the service transmission scheme supported in the broadcasting area of the neighboring cell. The service transmission scheme may be classified into a single-cell transmission scheme and a multi-cell transmission scheme. The single-cell transmission scheme may be a scheme where a broadcasting service is transmitted when the broadcasting area of the neighboring cell is a non-MBSFN area, and the multi-cell transmission scheme may be a scheme where a broadcasting service is transmitted when the broadcasting area of the neighboring cell is an MBSFN area. Accordingly, the MBMS type area 521 may indicate whether to provide an MBSFN.

Since the broadcasting area of the neighboring cell is the non-MBSFN area in a case of the single-cell transmission scheme, the MBMS area ID area 522 may include an MBMS area ID, and since the broadcasting area of the neighboring cell is the MBSFN area in a case of the multi-cell transmission scheme, the MBMS area ID area 522 may include an MBSFN area ID.

The channel configuration information area 523 may include configuration information of a logical channel required for providing broadcasting services. Specifically, in a case of a single-cell transmission scheme, the channel configuration information area 523 may include configuration information including channel shape information for a single cell. When an MCCH is used as the logical channel, the channel shape information may be shape information about an MCCH, and include a transmission cycle information and shape information of a lower layer. The shape information of the lower layer may be lower protocol setting information for an MCCH setting, and the lower layer (or lower protocol) may include a Packet Data Convergence Protocol (PDCP), a Radio Link Control (RLC), a Medium Access Control (MAC), and a Physical Layer (PHY) setting information.

Also, in a case of the multi-cell transmission scheme, the channel configuration information area 523 may further include MCH information used for reading the MCCH shape information as well as the shape information about the MCCH. The MCCH may be a control channel for the MBMS, and transmit control information for an MBMS transmission to the mobile station (MS). The MCH may be used for a multi-cell transmission.

Referring again to FIG. 4, the mobile station (MS) according to an embodiment includes a terminal communication unit 420, a storage unit 422, and a control unit 424.

The terminal communication unit 420 may receive broadcasting services from a serving cell where the mobile station (MS) is currently located. When the mobile station (MS) is moved to a neighboring cell, a broadcasting area of the neighboring cell may provide the same broadcasting service and the terminal communication unit 420 may receive the same broadcasting service.

Also, the terminal communication unit 420 may receive an SIB from the base station BS1. The received SIB may include the broadcasting area information of the neighboring cell which is described with reference to FIG. 5.

The storage unit 422 may store the received SIB.

The control unit 424 may determine whether a broadcasting area of a neighboring cell which the mobile station (MS) is moved to and a broadcasting area of a serving cell are the same, using the received SIB or the stored SIB, and provide broadcasting services selectively using the neighboring cell information area 500 among the SIBs based on the determined result.

Specifically, when the flag is set to ‘1’ in the first area 510 among the received SIBs, the control unit 424 may determine that the broadcasting areas of the neighboring cell and the serving cell are the same. Also, when the flag is set to ‘0’ in the first area 510, the control unit 424 may determine that the broadcasting areas of the neighboring cell and the serving cell are different from each other.

When the broadcasting area of the neighboring cell which the mobile station (MS) is moved to and the broadcasting area of the serving cell are different from each other, that is, when the serving cell and the neighboring cell are positioned within the same broadcasting area, the control unit 424 may control the terminal communication unit 420 to consecutively receive, from a base station of the neighboring cell, broadcasting services being received from the base station BS1 of the serving cell.

Also, when the broadcasting area of the neighboring cell which the mobile station (MS) is moved to and the broadcasting area of the serving cell are different from each other, the control unit 424 may control the terminal communication unit 420 to receive, from the neighboring cell, the broadcasting service being received from the serving cell, using the broadcasting area information included in the SIB. The control unit 424 may verify the channel configuration information area 523 to verify the configuration information of the logical channel transmitting the contents, and verify, using the verified configuration information, whether the neighboring cell provides the same broadcasting service.

When the neighboring cell provides the same broadcasting service, the control unit 424 may consecutively receive the broadcasting service from the neighboring cell while preventing a disruption of the broadcasting service from occurring, or receive the broadcasting service while minimizing a time during which the disruption of the broadcasting service occurs.

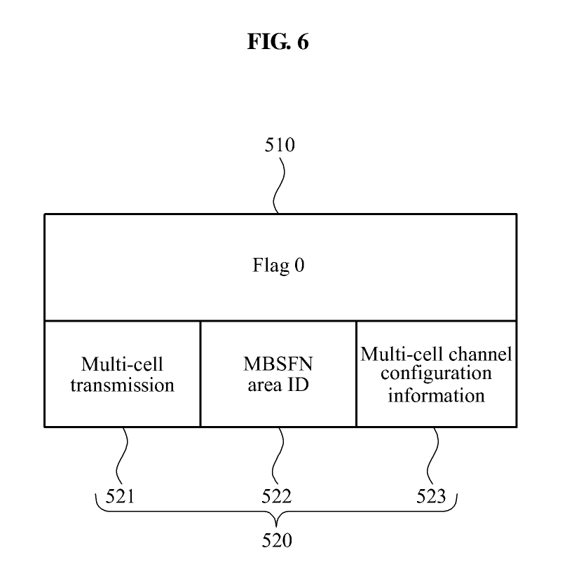

FIG. 6 is a diagram illustrating information included in a neighboring cell information area of an SIB when an MBMS type is a multi-cell transmission.

When the mobile station (MS) is moved to a neighboring cell, the control unit 424 may determine whether the neighboring cell is located in a different broadcasting area from a broadcasting area of a serving cell. For example, when the mobile station (MS) is moved to the neighboring cell, and receives an ID of the neighboring cell from a base station of the neighboring cell, the control unit 424 may determine whether the neighboring cell information area 500 corresponding to the received ID of the neighboring cell exists in the SIB.

When the neighboring cell information area 500 exists in the SIB as the determined result, since the flag is set to ‘0’ in the first area 510, the control unit 424 may determine that the broadcasting areas of the serving cell and the neighboring cell are different from each other. When a multi-cell transmission information is included in the MBMS type area 521 of the second area 520, the control unit 424 may determine that the broadcasting area of the neighboring cell is the MBSFN area. In FIG. 6, the control unit 424 may determine that the mobile station (MS) is moved from the MBSFN area to another MBSFN area.

The control unit 424 may obtain MCCH information from the neighboring cell, using information included in the neighboring cell information area 500, that is, information about the MBSFN area. Specifically, the control unit 424 may verify the channel configuration information area 523 to verify MCCH shape information for a plurality of cells, and obtain the MCCH information from the neighboring cell, using an MCH included in the verified shape information.

The control unit 424 may verify whether the broadcasting service being received from the serving cell is provided in the neighboring cell, based on the obtained MCCH information. When an ID of the broadcasting service being provided in the neighboring cell included in the obtained MCCH information and an ID of a broadcasting service provided from the serving cell are the same, the same broadcasting service may be provided even in the neighboring cell. The ID of the broadcasting service may be included in the message described with reference to FIGS. 2 and 3, and may be provided from the base station BS1 to the mobile station (MS), using the MCCH.

When the neighboring cell which the mobile station (MS) is moved to receives the same broadcasting service, the control unit 424 may acquire, from the base station of the neighboring cell, radio bearer information required for the broadcasting service to thereby perform a radio bearer re-setting, and control the terminal communication unit 420 to set related information relating to the traffic and to receive information related to traffic. The related information may be PDCP, RLC, MAC, and PHY information required for setting an MTCH for each of the broadcasting services.

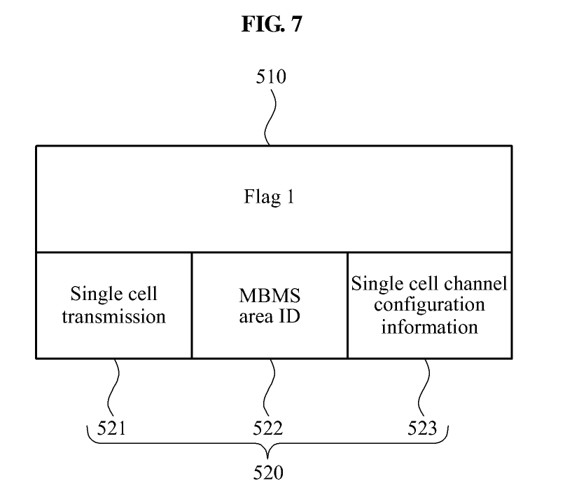

FIG. 7 is a diagram illustrating information included in a neighboring cell information area of an SIB when an MBMS type is a single cell transmission.

When a mobile station (MS) is moved to a neighboring cell, the control unit 424 may verify whether the neighboring cell is located in a different broadcasting area from a broadcasting area of a serving cell, which is a similar manner to that described in FIG. 6, and thus further descriptions thereof will be herein omitted. However, in FIG. 7, the control unit 424 may determine that the mobile station (MS) is moved from the MBSFN area to the non-MBSFN area. Since the flag ‘0’ is set in the first area 510, the control unit 424 may determine that the broadcasting areas of the serving cell and the neighboring cell are different from each other. When single-cell transmission information is included in the MBMS type area 521 of the second area 520, the control unit 424 may determine that the broadcasting area of the neighboring cell is the non-MBSFN area.

The control unit 424 may acquire MCCH information from the neighboring cell using information about the MBMS area included in the neighboring cell information area 500. Specifically, the control unit 424 may verify the channel configuration information area 523 to verify MCCH shape information for a single cell, and acquire the MCCH information from the neighboring cell using the verified MCCH shape information. The control unit 424 may verify whether a broadcasting service being received from the serving cell is provided even in the neighboring cell, based on the acquired MCCH information.

When the neighboring cell which the mobile station (MS) is moved to receives the same broadcasting service, the control unit 424 may acquire, from the base station of the neighboring cell, radio bearer information required for the broadcasting service to thereby perform a radio bearer re-setting, and control the terminal communication unit 420 to receive information related to traffic using the related information.

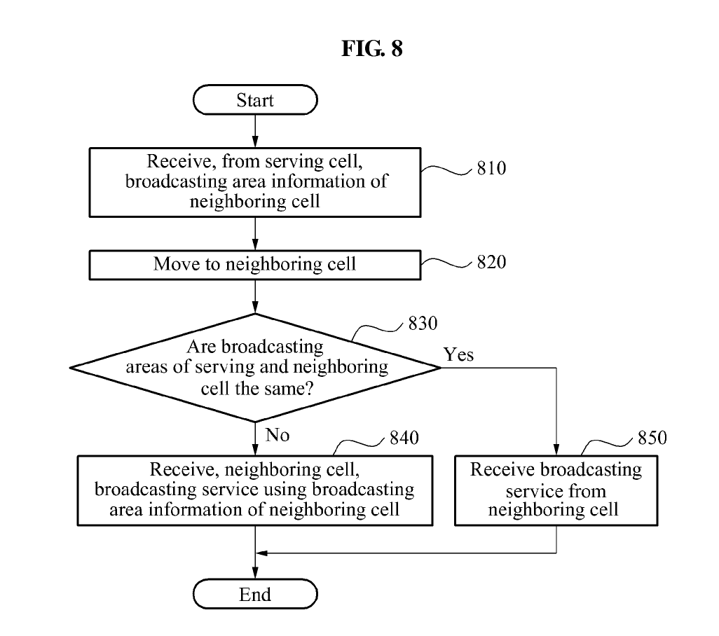

FIG. 8 is a flowchart illustrating a method of providing service continuity of a mobile station (MS) according to an embodiment of the present invention.

Referring to FIG. 8, in operation 810, the terminal communication unit 412 may receive an SIB from a base station BS1 of a serving cell while receiving a broadcasting service from the serving cell. The SIB received in operation 810 may include information about the broadcasting area of the neighboring cell, as illustrated in FIG. 5.

In operation 830, when the mobile station (MS) is moved to the neighboring cell in operation 820, the control unit 424 may verify whether a broadcasting area of the serving cell and a broadcasting area of the neighboring cell are different from each other.

In operation 840, when the broadcasting areas of the serving cell and the neighboring cell are different from each other based on a verified result of operation 830, the control unit 424 may set a radio resource using broadcasting area information of the neighboring cell, and control the terminal communication unit 420 to receive, from the neighboring cell, the broadcasting service being received from the serving cell. As a result, the mobile station (MS) may be consecutively provided with the broadcasting service from the base station of the neighboring cell without re-receiving the SIB.

In operation 850, when the broadcasting areas of the serving cell and the neighboring cell are the same based on the verified result of operation 830, the control unit 424 may receive the broadcasting service from the base station of the neighboring cell without performing a separate setting. However, when the neighboring cell does not provide a previous received broadcasting service, the broadcasting service may be terminated.

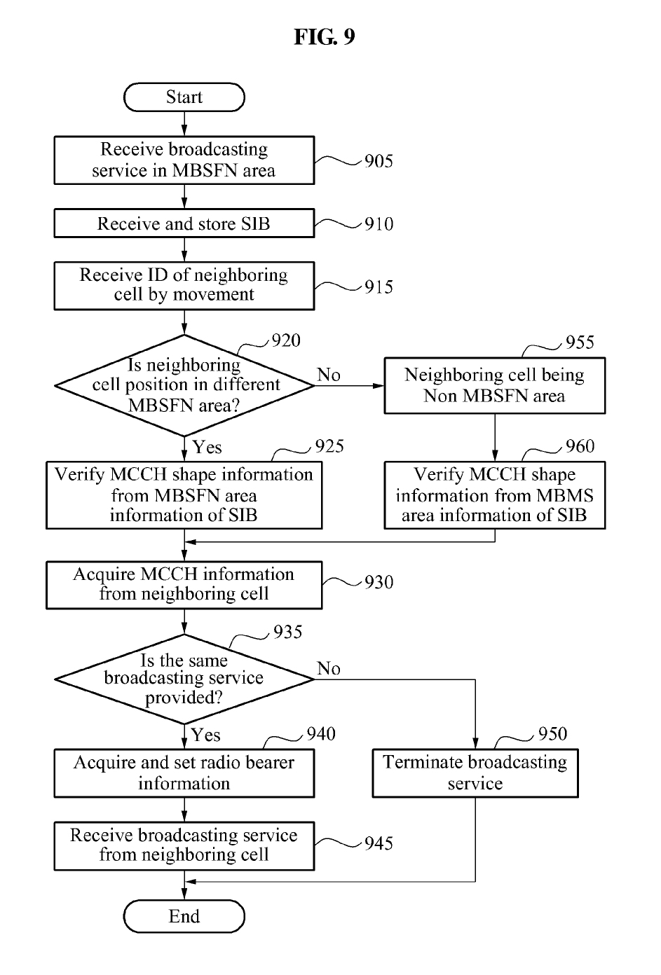

FIG. 9 is a flowchart illustrating a method of providing service continuity of a mobile station (MS) according to another embodiment of the present invention.

In operation 905, the mobile station (MS) may receive a broadcasting service (for example, ID=1 of the broadcasting service) in an MBSFN area where a serving cell is included, and transmit the received broadcasting service to a user.

In operation 910, the control unit 424 may receive an SIB provided from a base station BS1, and store the received SIB in the storage unit 422. The received SIB may map broadcasting area information of all neighboring cells in an ID of each of corresponding neighboring cells, and may include the mapped broadcasting area information.

In operation 915, when the mobile station (MS) is moved to the neighboring cell, the terminal communication unit 420 may receive the ID of the neighboring cell from the base station BS1 of the neighboring cell.

In operation 920, the control unit 424 may verify whether a broadcasting area of the neighboring cell and a broadcasting area (area 1) of the serving cell are different from each other. Specifically, the control unit 424 may verify the broadcasting area information mapped in the ID of the received neighboring cell among the received SIBs. And when a flag ‘0’ is set in the first area 510 of the verified broadcasting area information, and an MBSFN area ID is set in the MBMS area ID area 522, the control unit 424 may determine that the neighboring cell is another MBSFN area (area 2).

In operation 925, the control unit 424 may verify the channel configuration information area 523 among information about the MBSFN area, and verify an MCCH shape information for a plurality of cells.

In operation 930, the control unit 424 may acquire, from the neighboring cell, MCCH information through an MCH, using the verified shape information.

In operation 935, the control unit 424 may verify whether the broadcasting service being received from the serving cell is provided in the neighboring cell, based on the acquired MCCH information.

In operation 940, when the broadcasting service being received from the serving cell is provided in the neighboring cell based on a verified result of operation 935, the control unit 424 may acquire, from the base station of the neighboring cell, radio bearer information required for the broadcasting service to thereby perform a radio bearer re-setting.

In operation 945, the terminal communication unit 420 may receive, from the neighboring cell, information related to traffic and the broadcasting service using related information relating to the broadcasting service and the information related to traffic.

In operation 950, when the broadcasting service being received from the serving cell is not provided in the neighboring cell based on a verified result of operation 935, the control unit 424 may terminate the broadcasting service.

In operation 955, when the flag 0 is set in the first area 510, and the MBMS area ID is set in the MBSFN area ID area 522 based on a verified result of operation 920, the control unit 424 may determine that the neighboring cell is included in the non-MBSFN area, that is, the MBMS area.

In operation 960, the control unit 424 may verify the channel configuration information area 523 among information about the MBMS area to thereby verify MCCH shape information for a single cell.

Next, the control unit 424 may perform operations 930 to 950. However, in operation 945, the terminal communication unit 420 may acquire, from the neighboring cell, MCCH information using the verified shape information.

As described above, according to an embodiment, when a mobile station (MS) is moved between the same or different broadcasting areas while receiving a broadcasting service in a mobile communication network, broadcasting area information of the neighboring cell may be added to the SIB used at the time of handover, without performing a separate operation, so that a time during which a disruption of the broadcasting service occurs may be minimized, or the disruption of the broadcasting service may be removed.

Also, according to an embodiment, when the mobile station (MS) is moved from the serving cell to the neighboring cell, the same broadcasting service may be received from the neighboring cell using an SIB previously received from the serving cell. As a result, the same broadcasting service is received without re-receiving the SIB from the neighboring cell, thereby minimizing or reducing a disruption phenomenon of the broadcasting service.

The methods according to the above-described embodiments may be recorded in non-transitory computer-readable storage media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few embodiments have been shown and described, it would be appreciated by those skilled in the art that changes may be made in these embodiments without departing from the principles and spirit of the disclosure, the scope of which is defined by the claims and their equivalents.

What is claimed is:

1. A base station for providing service continuity between Multimedia Broadcast and Multicast Service (MBMS) areas, the base station comprising:
a system information generation unit to generate a system information block including information about a broadcasting area providing a broadcasting service to a neighboring cell of a serving cell where a mobile station is located; and
a communication unit to transmit the generated system information block to the mobile station.

2. The base station of claim 1, wherein the information about the broadcasting area included in the system information block comprises a service transmission scheme supported in a broadcasting area of the neighboring cell, identification information of the broadcasting area of the neighboring cell, and configuration information of a logical channel transmitting contents.

3. The base station of claim 2, wherein, when the service transmission scheme is a single cell transmission scheme providing a service to only a single cell, the configuration information comprises channel shape information about the single cell, and when the service transmission scheme is a multi-cell transmission scheme providing a service to a plurality of cells, the configuration information comprises channel shape information about the transmission channel.

4. The base station of claim 1, wherein the system information block further comprises a flag indicating whether broadcasting areas providing the broadcasting service to the serving cell and the neighboring cell, respectively, are the same.

5. The base station of claim 1, wherein, when the broadcasting area providing the broadcasting service to the neighboring cell and a broadcasting area providing the broadcasting service to the serving cell are different from each other, the system information generation unit generates the system information block including information about the broadcasting area of the neighboring cell.

6. The base station of claim 1, wherein the broadcasting area is one of a non-Multicast Broadcast Single Frequency Network (MBSFN) area and an MBSFN area.

7. A mobile station for providing service continuity between MBMS areas, while the mobile station receives a broadcasting service from a serving cell, the mobile station comprising:
a communication unit to receive, from a base station, a system information block including information about a broadcasting area providing the broadcasting service to a neighboring cell of the serving cell; and
a control unit to control the communication unit to receive, from the neighboring cell, the broadcasting service being received from the serving cell, using the information about the broadcasting area, when a broadcasting area of the neighboring cell obtained when the mobile station is moved and a broadcasting area of the serving cell are different from each other.

8. The mobile station of claim 7, wherein the information about the broadcasting area included in the received system information block comprises a service transmission scheme supported in the broadcasting area of the neighboring cell, identification information of the broadcasting area of the neighboring cell, and configuration information of a logical channel transmitting contents.

9. The mobile station of claim 8, wherein, when the service transmission scheme is a single cell transmission scheme providing a service to only a single cell, the configuration information comprises logical channel shape information about the single cell, and when the service transmission scheme is a multi-cell transmission scheme providing a service to a plurality of cells, the configuration information comprises logical channel shape information about the transmission channel.

10. The mobile station of claim 8, wherein the control unit verifies whether the broadcasting area of the neighboring cell provides the broadcasting service being received from the serving cell, using the configuration information of the logical channel.

11. The mobile station of claim 7, wherein the system information block further comprises a flag indicating whether the broadcasting area of the serving cell and the broadcasting area of the neighboring cell are the same, and the control unit determines whether the neighboring cell is located in the broadcasting area different from the broadcasting area of the serving cell based on the flag.

12. The mobile station of claim 7, wherein each of the broadcasting area of the serving cell and the broadcasting area of the neighboring cell is one of a single cell transmission area providing a service to only a single cell, and a multi-cell transmission area providing a service to a plurality of cells.

13. The mobile station of claim 7, wherein each of the broadcasting area of the serving cell and the broadcasting area of the neighboring cell is a non-MBSFN area or an MBSFN area.

14. A method of providing service continuity between MBMS areas with respect to a mobile station, while the mobile station receives a broadcasting service from a serving cell, the method comprising:
receiving, from the serving cell, a system information block including information about a broadcasting area providing the broadcasting service to a neighboring cell of the serving cell;
verifying whether a broadcasting area of the neighboring cell is different from a broadcasting area of the serving cell when the mobile station moves to the neighboring cell; and
receiving, from the neighboring cell, the broadcasting service being received from the serving cell using the information about the broadcasting area, when the broadcasting area of the neighboring cell is different from the broadcasting area of the serving cell.

15. The method of claim 14, wherein the information about the broadcasting area included in the received system information block comprises a service transmission scheme supported in the broadcasting area of the neighboring cell, identification information of the broadcasting area of the neighboring cell, and configuration information of a logical channel transmitting contents.

16. The method of claim 15, wherein, when the service transmission scheme is a single cell transmission scheme providing a service to only a single cell, the configuration information comprises logical channel shape information about the single cell, and when the service transmission scheme is a multi-cell transmission scheme providing a service to a plurality of cells, the configuration information comprises logical channel shape information about the transmission channel.

17. The method of claim 15, wherein, after the verifying, further comprises:
verifying whether the broadcasting area of the neighboring cell provides the broadcasting service being received from the serving cell, using the configuration information of the logical channel.

18. The method of claim 14, wherein the system information block further comprises a flag indicating whether the broadcasting area of the serving cell and the broadcasting area of the neighboring cell are the same, and the verifying determines whether the neighboring cell is located in the broadcasting area different from the broadcasting area of the serving cell based on the flag.

19. The method of claim 14, wherein each of the broadcasting area of the serving cell and the broadcasting area of the neighboring cell is one of a single cell transmission area providing a service to only a single cell, and a multi-cell transmission area providing a service to a plurality of cells.

20. The method of claim 14, wherein each of the broadcasting area of the serving cell and the broadcasting area of the neighboring cell is one of a non-MBSFN area and an MBSFN area.
